(19) United States
(12) Patent Application Publication
(10) Pub. No.: US 2001/0016545 A1
(43) Pub. Date: Aug. 23, 2001

(54) Floating tool changer for an automobile

(76) Inventor: In Ho Jeong, Ulsan (KR)

Correspondence Address: BIRCH STEWART KOLASCH & BIRCH, PO BOX 747, FALLS CHURCH, VA, 22040-0747, US

(21) Appl. No.: 09/749,682

(22) Filed: Dec. 28, 2000

(30) Foreign Application Priority Data
Dec. 30, 1999 (KR) 1999-66276

(51) Int. Cl. B23Q 3/155

(52) U.S. Cl. 483/13; 483/58; 483/65

(57) ABSTRACT

The present invention relates to a floating tool changer for an automobile and more particularly, to a floating tool changer for an automobile which can set at least two different floating tools simultaneously and exchange a socket portion of the floating tool by using a desirable grip means automatically so that the floating tool changer is applicable to in assembly lines for variety kinds of automobiles and thus, a productivity and an operation efficiency can be enhanced.

### BACKGROUND OF THE INVENTION

1. Field of the invention

The present invention relates to a floating tool changer for an automobile and more particularly, to a floating tool changer for an automobile which can set at least two different floating tools simultaneously and exchange a socket portion of the floating tool by using a desirable grip means automatically so that the floating tool changer is applicable to in assembly lines for variety kinds of automobiles and thus, a productivity and an operation efficiency can be enhanced.

2. Description of the Prior Art

In general, a floating tool is used for combining a bolt and nut of a front suspension, a cross member and a center member in an automobile assembly line.

As shown in FIG. 1, such floating tool 10 consists of a socket 12 which is floatable upwardly and downwardly by a spring 11 located at lower end thereof, a housing 13 supporting the spring 11 and the socket 12, a mounting bracket 14 which enables an entire tool to fix to a robot, and a nut runner 15 combining a bolt and nut at in a proper torque.

As shown in FIG. 2, such floating tool 10 is mounted to a 6-axis multi articulation robot 16, and is then used in an automobile assembly line.

Since such floating tool 10 is standardized suitable for one automobile model only, in order to apply the floating tool to an another model of automobile, it has to be changed. This inefficient defect causes that a productivity and an operation efficiency in the automobile assembly line become lowered.

In order to solve this drawback, it is possible to use the 6-axis multi articulation robot to which the floating tools suitable for two kinds of the automobile, respectively, are mounted. However, in this case, a weight of the robot is increased and exceeds the capability of the robot. Further, it makes the work progress tardy.

### SUMMARY OF THE INVENTION

Therefore, an object of the present invention is to provide a floating tool changer for an automobile which can support two different kinds of the floating tools by using a grip means, and has a rising means so that it is possible to exchange different kinds of the floating tools in a line easily. Therefore, work efficiency related to use of the floating tool can be sought and productivity and operation efficiency can be enhanced.

### BRIEF DESCRIPTION OF THE DRAWINGS

For fuller understanding of the nature and objects of the invention, reference should be had to the following detailed description taken in, conjunction with the accompanying drawings in which:

FIG. 1 is a sectional view showing a conventional floating tool.

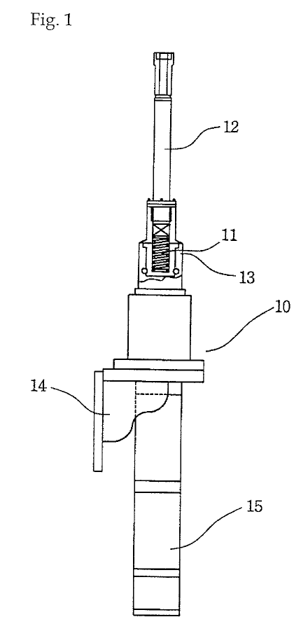

FIG. 2 is a schematic view of the conventional floating tool in use.

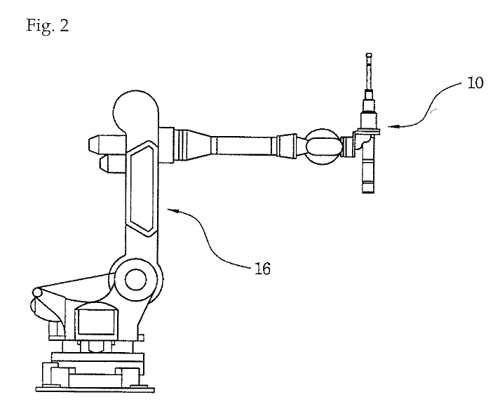

FIG. 3 is a front view of a floating tool changer according to the present invention; and

FIG. 4 is a side view of FIG. 3.

### DETAILED DESCRIPTION OF THE INVENTION

The present invention comprises two pairs of units of which one is an upper air chuck cylinder 20 which can clamp a floating tool housing and the other is an upper grip 21 and a lower air chuck cylinder 22 which can clamp a floating tool body and a lower grip 23. The upper air chuck cylinder 20 and the upper grip 21 are movable vertically by a cylinder type robot 24. The present invention further comprises a first proximity sensor 25 for sensing a rising position of the floating tool housing, a second proximity sensor 26 as a safe-guard which senses a position of a floating tool socket and the housing to restrain an unclamping movement of the upper air chuck cylinder 20 and the upper grip 21, a bracket means 27 and a frame means 28 supporting each member.

Specially, the robot 24 is provided with a stopper 29 which can maintain a definite location of the floating tool socket and the floating tool housing when the floating tool socket and the floating tool housing are detached.

The present invention is described in detail hereunder.

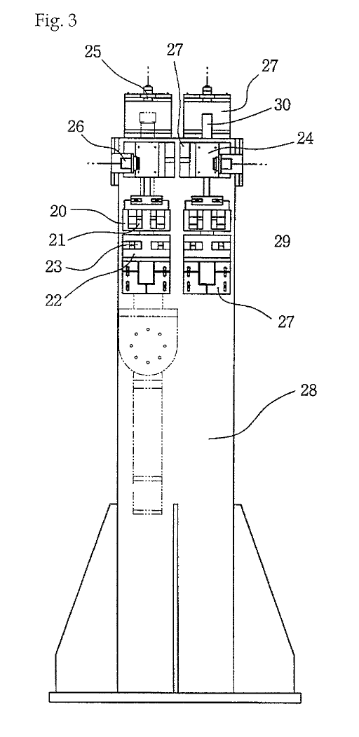

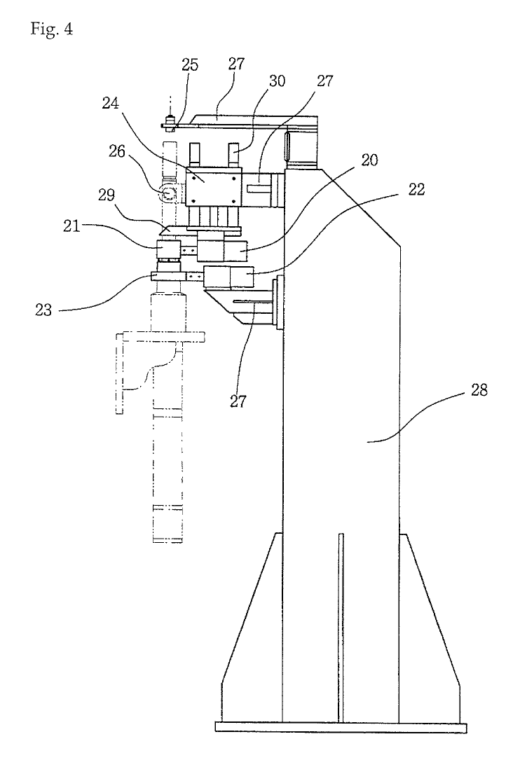

FIG. 3 and FIG. 4 are the front view and the side view showing a structure of the floating tool changer according to the present invention.

The floating tool changer of the present invention composes the upper air chuck cylinder 20 and the upper grip 21, the lower air chuck cylinder 22 and the lower grip 23, and the cylinder type robot 24 as one unit to be arranged in line.

A unit of the upper air chuck cylinder 20 and the upper grip 21 and the other unit of the lower air chuck cylinder 22 and the lower grip 23 are arranged vertically with a proper interval. The floating tool body and the floating tool housing 13 are held by each grip. Especially, the upper air chuck cylinder 20 and the upper grip 21 are combined integrally at a lower end portion of the cylinder type robot 24 so that the upper air chuck cylinder 20 and the upper grip 21 move vertically together with operation of the robot 24.

Each side of cylinder type robot 24 has a guide bar 30 which guides a vertical movement of the upper air chuck cylinder 20, the upper grip 21 and the stopper 29.

Also, the stopper 29 is installed integrally on upper end of the upper air chuck cylinder 20, and thus the stopper 29 can hold the floating tool housing 13 and socket 12 from the top to be maintained the consistent position after the floating tool housing 13 and socket 12 are detached.

The first proximity sensor 25 is installed on the upper portion of the frame means 28 by the bracket 27 extended forwardly to sense a raise position of the detached floating tool housing 13 and the socket 12. At this time, the first proximity sensor 25 is located on the central clamping line of the upper and lower grips 21 and 23.

Also, the second proximity sensor 26 is installed on both sides of an upper position of the frame means 28 to sense the existence of the floating tool housing 13 and the socket 12 so that it is possible to prevent an accident such as falling of the floating tool housing 13 and the socket 12.

That is, when an unclamping signal is supplied to the upper air chuck cylinder 20 and the upper grip 21 which hold the floating tool housing 13 and the socket 12 by the work's carelessness, an unclamping function of the floating tool housing 13 and the socket 12 can not be performed by a sensing signal of the second proximity sensor 26 so that it can prevent from falling of the floating tool housing 13 and the socket 12 and causing an accident hurting the worker.

A method for changing the floating tool by means of the floating tool changer according to the present invention is described hereunder.

In the automobile assembly line, when another kind of the automobile has to be assembled after an assembly process for a certain kind of the automobile by using the 6-axis multi articulation robot and the floating tool, the floating tool is entered into the upper grip 21 of the upper air chuck cylinder 20 and the lower grip 23 of the lower air chuck cylinder 22 which are located at a right side and then a housing portion and a body portion of the floating tool are clamped, respectively.

Thereafter, the cylinder type robot 24 is operated to move the upper air chuck cylinder 20 and the upper grip 21 toward an upper portion, thereupon the socket and the housing are detached from the body of the floating tool.

The lower grip 23 of the lower air chuck 22, which holds the body of the floating tool, is unclamped and simultaneously, the floating tool bodyis moved toward left side by 6-axis multi articulation robot to enter to the lower portion of the housing and the socket clamped on the upper air chuck cylinder 20 and the upper grip 21 at a left suitable for the automobile which is to be changed.

After aligning the positions, the floating tool body is moved upward by 6-axis multi articulation robot and rotates a cylindrical casing where the housing will be inserted and combined. According as the floating tool body is moved upward continuously, the socket and housing are combined into the floating tool body.

Once the socket and housing suited for the changed automobile model are combined with the floating tool body as described above, the upper air chuck cylinder 20 and the upper grip 21 become an unclamped state and the 6-axis multi articulation robot is moved simultaneously so that the change operation of the floating tool is completed.

As the foregoing, the present invention provides the means which can change the floating tool easily in the automobile assembly line so that the present invention is applicable to in assembly lines for variety kinds of automobiles, whereby it is possible to promote work efficiency related to use a floating tool, and a productivity and an operation efficiency can be enhanced.

Although this invention has been described in its preferred form with a certain degree of particularity, it is appreciated by those skilled in the art that the present invention disclosure of the preferred form has been made only by way of example and that numerous changes in the details of the construction, combination and arrangement of parts may be resorted to without departing from the spirit and scope of the invention.

What is claimed is:

1. A floating tool changer for an automobile comprising; a pair of units of which one is an upper air chuck cylinder and an upper grip for clamping a floating tool housing, and the other is a lower air chuck cylinder and a lower grip for clamping a floating tool body; a first proximity sensor applicable to move said upper air chuck cylinder and said upper grip vertically by a cylindrical robot and sensing a raised position of the floating tool housing; a second proximity sensor acting as a safe-guard by sensing whether said floating tool socket and said housing are existed to restrain an unclamping movement of said upper air chuck cylinder and said upper grip; and a bracket means and a frame means for supporting said members.

2. The floating tool changer for the automobile according to claim 1, said robot is provided with a stopper which can maintain a definite location of said floating tool socket and the floating tool housing when said floating tool socket and said floating tool housing are detached.
